(19) United States
(12) Patent Application Publication
(10) Pub. No.: US 2012/0278712 A1
(43) Pub. Date: Nov. 1, 2012

(54) MULTI-INPUT GESTURES IN HIERARCHICAL REGIONS

(75) Inventors: Stephen H. Wright, Bothell,, WA (US); Amish Patel, Seattle,, WA (US); Paul Armistead Hoover, Bothell,, WA (US); Nicholas R. Waggoner, Newcastle,, WA (US); Michael J. Patten, Sammamish,, WA (US)

(73) Assignee: MICROSOFT CORPORATION, Redmond, WA (US)

(21) Appl. No.: 13/095,495

(22) Filed: Apr. 27, 2011

(51) Int. Cl. G06F 3/041; G06F 3/01

(52) U.S. Cl. 715/702; 345/173

(57) ABSTRACT

This document describes techniques and apparatuses for multi-input gestures in hierarchical regions. These techniques enable applications to appropriately respond to a multi-input gesture made to one or more hierarchically related regions of an application interface.

### BACKGROUND

Multi-input gestures permit users to selectively manipulate regions within application interfaces, such as webpages. These multi-input gestures permit many manipulations difficult or impossible with single-input gestures. For example, multi-input gestures can permit zooming in or out of a map in a webpage, panning through a list on a spreadsheet interface, or rotating a picture of a graphics interface. Conventional techniques for handling multi-input gestures, however, often associate a gesture with a region that was not intended by the user.

### SUMMARY

This document describes techniques for multi-input gestures in hierarchical regions. These techniques determine an appropriate region of multiple, hierarchically related regions to associate a multi-input gesture. By so doing, a user may input a multi-input gesture into an application interface and, in response, the application interface manipulates the region logically and/or as intended by the user.

This summary is provided to introduce simplified concepts for multi-input gestures in hierarchical regions that are further described below in the Detailed Description. This summary is not intended to identify essential features of the claimed subject matter, nor is it intended for use in determining the scope of the claimed subject matter. Techniques and/or apparatuses for multi-input gestures in hierarchical regions are also referred to herein separately or in conjunction as the “techniques” as permitted by the context.

### BRIEF DESCRIPTION OF THE DRAWINGS

Embodiments for multi-input gestures in hierarchical regions are described with reference to the following drawings. The same numbers are used throughout the drawings to reference like features and components:

FIG. 1 illustrates an example system in which techniques for multi-input gestures in hierarchical regions can be implemented.

FIG. 2 illustrates an example embodiment of the computing device of FIG. 1.

FIG. 3 illustrates an example embodiment of the remote provider of FIG. 1.

FIG. 4 illustrates an example method for multi-input gestures in hierarchical regions.

FIG. 5 illustrates a touch-screen display and application interfaces of FIG. 1 in greater detail.

FIG. 6 illustrates a multi-input gesture made to one of the application interfaces of FIGS. 1 and 5 and a response from a superior region that expands the application interface within the touch-screen display.

FIG. 7 illustrates an example method for multi-input gestures in hierarchical regions that can operate separate from, in conjunction with, or as a more-detailed example of portions of the method illustrated in FIG. 4.

FIG. 8 illustrates a response to a multi-input gesture made through one of the application interfaces of FIG. 1, 5, or 6, the response from an inferior region that expands that region within the application interface.

FIG. 9 illustrates an example device in which techniques for multi-input gestures in hierarchical regions can be implemented.

### DETAILED DESCRIPTION

Overview

This document describes techniques and apparatuses for multi-input gestures in hierarchical regions. These techniques enable applications to appropriately respond to a multi-input gesture made to one or more hierarchically related regions of an application interface.

Assume, for example, that a user wishes to expand an application interface to fit the user's screen. Assume also that the application has three different regions, one of which is hierarchically superior to the other two. If the user makes a zoom-out (e.g., spread or diverge) multi-input gesture where his or her fingers apply to different regions, current techniques often expand one of the inferior regions within the application interface or pan both of the inferior regions.

The techniques described herein, however, appropriately associate the multi-input gesture with the superior region, thereby causing the application interface to fill the user's screen. The techniques may do so, in some cases, based on the hierarchy of the regions and the capabilities of each region with respect to a received multi-input gesture.

This is but one example of the many ways in which the techniques enable users to manipulate regions of an application interface. Numerous other examples, as well as ways in which the techniques operate, are described below.

This discussion proceeds to describe an example environment in which the techniques may operate, methods performable by the techniques, and an example apparatus.

Example Environment

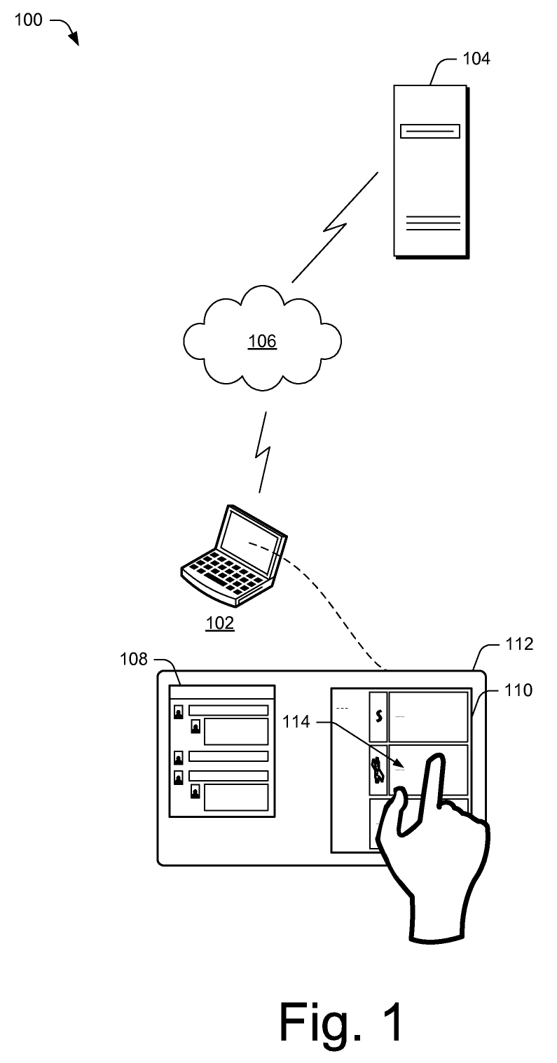

FIG. 1 illustrates an example environment 100 in which techniques for multi-input gestures in hierarchical regions can be embodied. Environment 100 includes a computing device 102, remote provider 104, and communication network 106, which enables communication between these entities. In this illustration, computing device 102 presents application interfaces 108 and 110 on touch-screen display 112, both of which include hierarchically related regions. Computing device 102 receives a multi-input gesture 114 made to application interface 110 and through touch-screen display 112. Note that the example touch-screen display 112 is not intended to limit the gestures received. Multi-input gestures may include one or more hands, fingers, or objects and be received directly or indirectly, such as through a direct-touch screen or an indirect touch screen or device, such as a kinect or camera system. The term “touch,” therefore, applies to a direct touch to a touch screen as described herein, but also to indirect touches, kinect-received inputs, camera-received inputs, and/or pen/stylus touches, to name just a few. Note also that a same or different types of touches can be part of a same gesture.

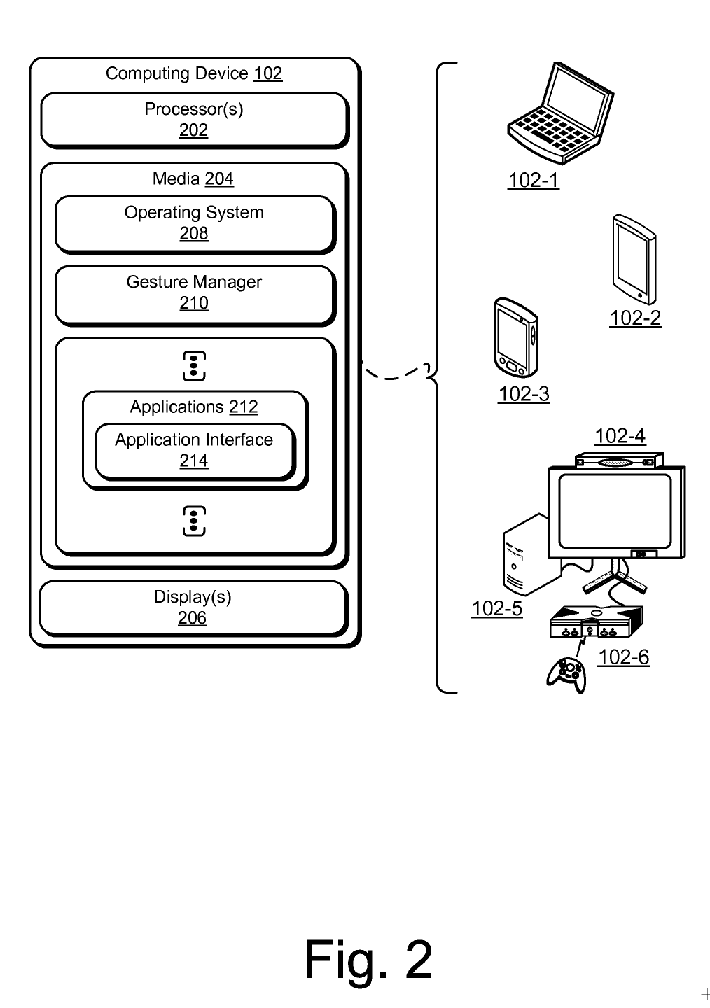

FIG. 2 illustrates an example embodiment of computing device 102 of FIG. 1, which is illustrated with six examples devices: a laptop computer 102-1, a tablet computer 102-2, a smart phone 102-3, a set-top box 102-4, a desktop computer 102-5, and a gaming device 102-6, though other computing devices and systems, such as servers and netbooks, may also be used.

Computing device 102 includes or has access to computer processor(s) 202, computer-readable storage media 204 (media 204), and one or more displays 206, four examples of which are illustrated in FIG. 2. Media 204 includes an operating system 208, gesture manager 210, and applications 212, each of which is capable of providing an application interface 214. In some cases application 212 provides application interface 214 in conjunction with a remote device, such as when the local application is a browser and the remote device includes a network-enabled service provider.

Gesture manager 210 is capable of targeting a multi-input gesture 114 received through an application interface (e.g., interfaces 108, 110, and/or 214) to a region of the application of the interface.

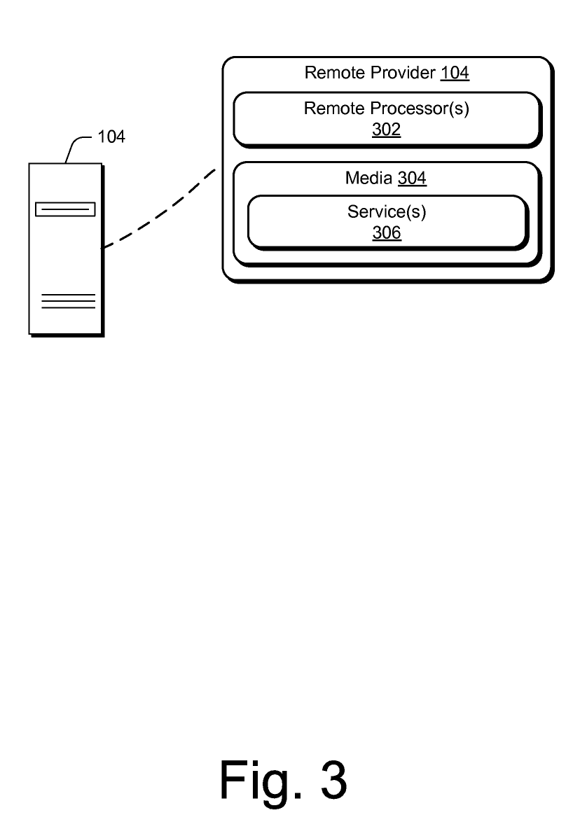

FIG. 3 illustrates an example embodiment of remote provider 104. Remote provider 104 is shown as a singular entity for visual brevity, though multiple providers are contemplated by the techniques. Remote provider 104 includes or has to access to provider processor(s) 302 and provider computer-readable storage media 304 (media 304). Media 304 includes services 306, which interact with users through application interfaces 214 of computing device 102 (e.g., displayed on display 206 or touch-screen display 112). These application interfaces 214 can be provided separate from, or in conjunction with, one or more of applications 212 of FIG. 2.

Ways in which entities of FIGS. 1-3 act and interact are set forth in greater detail below. The entities illustrated for computing device 102 and/or remote provider 104 can be separate or integrated, such as gesture manager 210 being integral or separate from operating system 208, application 212, or service 306.

### Example Methods

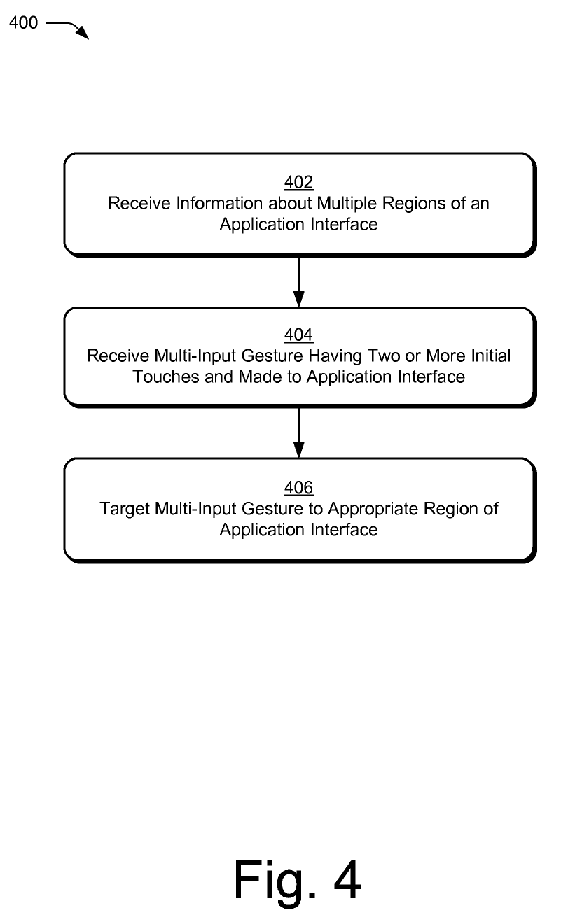

FIG. 4 depicts a method 400 for multi-input gestures in hierarchical regions. In portions of the following discussion reference may be made to environment 100 of FIG. 1 and as detailed in FIGS. 2-3, reference to which is made for example only.

Block 402 receives, from an application associated with an application interface, information about multiple regions of the application interface. This information can include hierarchical relationships, such as which regions are superior to which others, a size, location, and orientation of each region within the application interface and/or display (e.g., which pixels are of each region), and a response capability to multi-input gestures of each region.

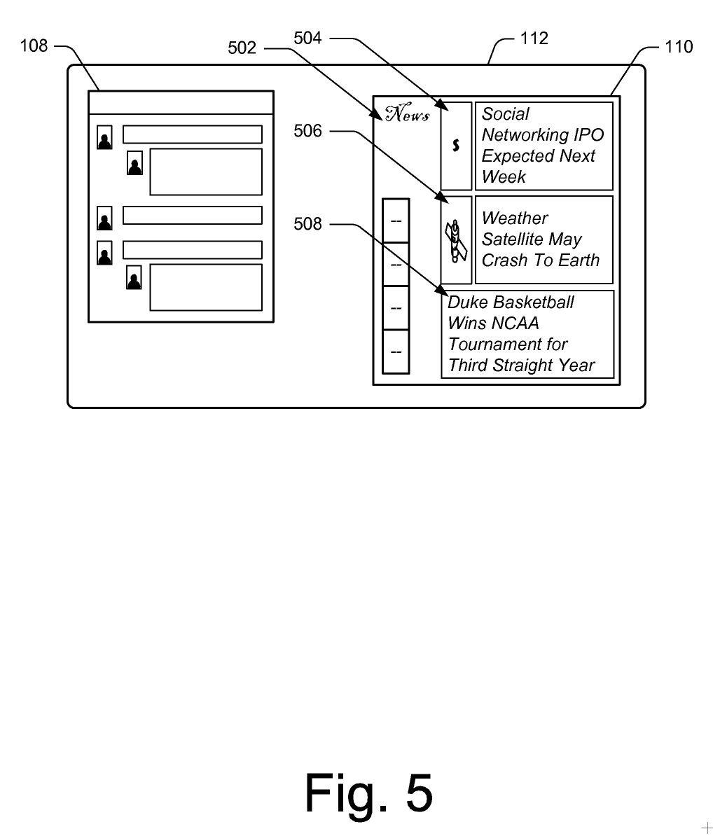

By way of example, consider FIG. 5, which illustrates touch-screen display 112 and application interfaces 108 and 110, all as in FIG. 1 but shown in greater detail. Application interface 110 is provided by a browser-type of application 212 of FIG. 2 in conjunction with service 306 of FIG. 3. Application interface 110 includes at least four regions, namely superior region 502, which is shown including inferior regions 504, 506, and 508. These hierarchical relationships can be those of a root node for superior region 502 and child nodes for regions 504, 506, and 508, such as seen in various hierarchical or structural documents (e.g., a markup-language document following the structure of many computing languages like eXtensible Markup Language (XML)). In simplistic pseudo code this can be shown as follows:

```
Superior Region 502
    Inferior Region 504
    Inferior Region 506
    Inferior Region 508
End Superior Region 502
```

For this example assume that gesture manager 210 receives the hierarchical relationships and which multi-input gestures each region can accept. Here all four regions can accept a pinch/spread or converge/diverge gesture (often used to zoom out or in), in the case of region 502 the divergence gesture expands all of application interface 110 (e.g., to the size of touch-screen display 112), and each of regions 504, 506, and 508 accept the divergence gesture to expand the news article associated with that region within the current size of application interface 110. Note, however, that other responses may also or instead be used, such as to show in a same-sized region a higher resolution of content, in which case some of the content may cease to be shown.

Block 404 receives a multi-input gesture having two or more initial touches (direct, indirect, or however received) made to an application interface having a superior region and at least one inferior region. In some cases the multi-input gesture is received from a device directly, such as touch-screen display 112, while in other cases the gesture is received from the application associated with the application interface or an operating system. Thus, the form of reception for the multi-input gesture can vary—it can be received as touch hits indicating locations on the application interface through which the gesture is received. In other cases, such as when received from application 212, the multi-input gesture is instead received with a indication of which regions the initial touches where received (e.g., one touch to superior region 502 and one touch to inferior region 508).

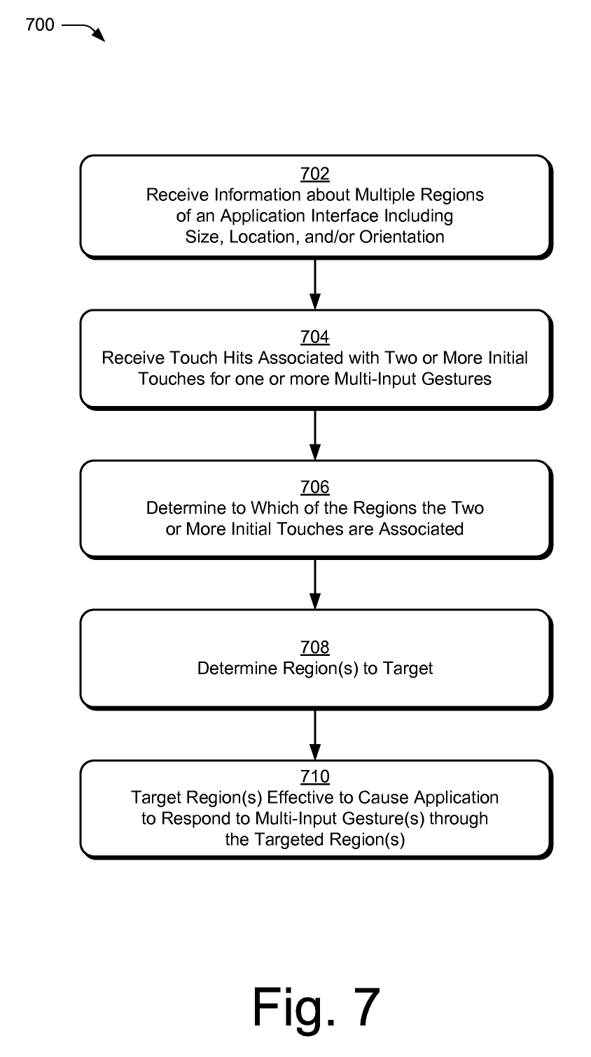

Method 400 addresses the scenario where the multi-input gesture is received having an indication of which region of an application interface the initial touches are made. Method 700 of FIG. 7, described following method 400, describes alternate cases.

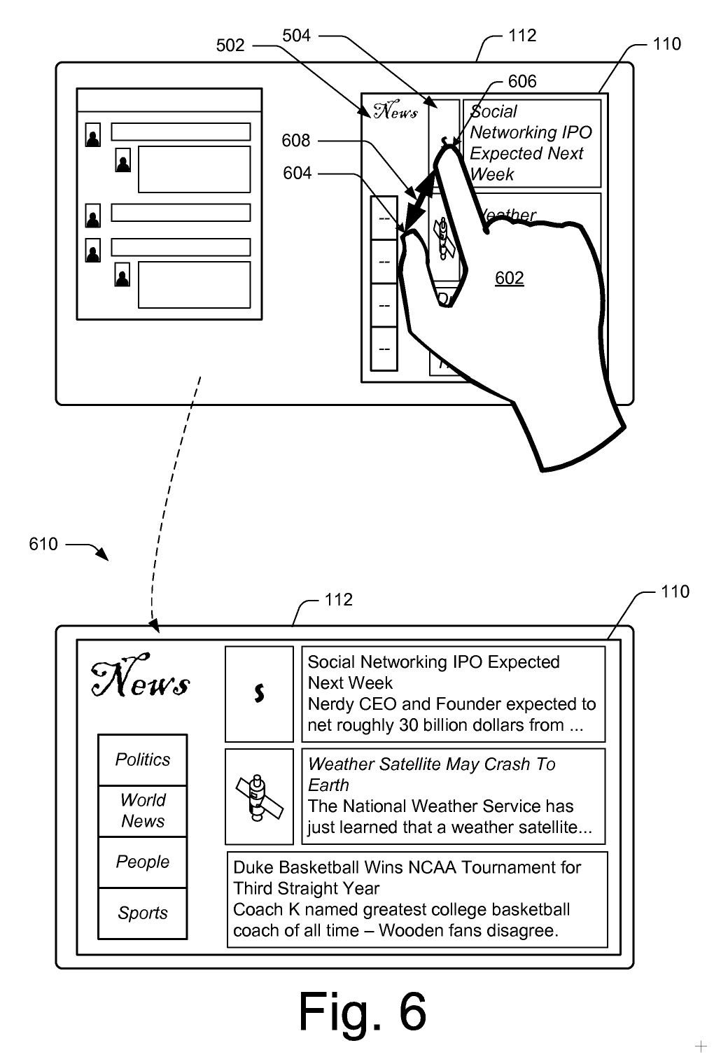

Continuing the ongoing embodiment, consider FIG. 6, which shows a multi-input gesture 602 made to application interface 110 through touch-screen display 112. This multi-input gesture 602 has two initial touches 604 and 606 to superior region 502 and inferior region 504, respectively. As noted, assume here that gesture manager 210 receives, from a browser-type of application 212 of FIG. 2, an indication of which region each initial touch is made (502 and 504).

Block 406 targets the multi-input gesture to an appropriate region. Generally, block 406 targets to the superior region if the superior region is capable of responding to the multi-input gesture and at least one of the two or more initial touches is made to the superior region, or the superior region is capable of responding to the multi-input gesture and the two or more initial touches are made to at least two different inferior regions.

In some cases block 406 targets also to the superior region outside of these two cases, such as if the superior region is capable of responding to the multi-input gesture and the two or more initial touches are made to a same or different inferior regions but the same inferior region or the different inferior regions are not capable of responding to the multi-input gesture.

Thus, there are cases where the multi-input gesture is not targeted to the superior region. For example, block 406 may target the multi-input gesture to the inferior region if the inferior region is capable of responding to the multi-input gesture and the two or more initial touches are made to only the inferior region.

The targeting of block 406 is based on at least some of the information received at block 402. In the above general cases, gesture manager 210 targets to an appropriate region based on the hierarchy of the regions, to which region(s) the initial touches are made, and the capabilities of at least the superior region. As part of block 406, the application associated with the application interface is informed of the targeting, such as with an indication of which region should respond to the multi-input gesture. How this is performed depends in part on whether gesture manager 210 is integral or separate from application 212, operating system 208, services 306, and/or device-specific software, such as a driver of touch-screen display 112.

Consider again the ongoing example illustrated in FIG. 6. Note here that two initial touches are received by application 212, which then indicates which regions (502 and 504) receive the touches to gesture manager 210. Gesture manager 210 then determines, based on the superior region begin capable of responding to a multi-input gesture and that the initial touches are located in superior region 502 and inferior region 504, to target the gesture to superior region 502.

Gesture manager 210 then indicates this targeting to application 212 effective to cause application 212 to respond to the multi-input gesture, which in this case is a spread/diverge gesture (shown at arrow 608). Concluding the ongoing example, application 212 responds to a divergence gesture by expanding application interface 110 to a larger size, here most of the screen of touch-screen display 112, shown also in FIG. 6 at 610.

Note that in some cases one of the initial touches of a multi-input gesture is received before the other(s). In such a case the techniques may immediately target the first initial touch to the region in which it is received. By so doing, very little if any user-perceivable delay is created, because the application may quickly respond to this first initial touch. Then, if no other touch is made, or a subsequent touch cannot be used (e.g., it is deemed a mistake or no region can respond to it), the region still responded quickly. When the second initial touch is received the techniques then target as noted in method 400.

Altering the above example, assume that initial touch 606 is received first. Gesture manager 210 targets this touch to inferior region 504 in which it was received. Application 212 then begins to respond, such as by altering the region by scrolling down in the article entitled: Social Networking IPO Expected Next Week. When the second touch is received, the above proceeds as shown at 610 in FIG. 6. In this case application interface 110 can show the partial scrolling or reverse the alteration (e.g., roll it back) based on that initial touch not intended to be a single-input gesture to scroll the article in inferior region 504.

FIG. 7 depicts a method 700 for multi-input gestures in hierarchical regions that can operate separate from, in conjunction with, or as a more-detailed example of portions of method 400.

Block 702 receives information about multiple regions of an application interface including size, location, and/or orientation of each of the regions. Block 702 is similar to block 402 of method 400, as it also receives information about the hierarchy and capabilities of the regions.

Block 704 receives touch hits associated with two or more initial touches for one or more multi-input gestures received through the application interface, the touch hits indicating location information on the application interface where the touch hits are received. Thus, gesture manager 210, for example, may receive location information indicating which pixel or pixels of a display are initially touched, an X-Y coordinate, or other location information sufficient to determine to which region a touch is intended. These touch hits may be received from application 212, directly from a device or device driver, or indirectly from operating system 208, to name just a few.

Block 706 determines, based on the touch hits, to which of said regions the two or more initial touches are associated. Gesture manager 210 may do so in various manners, such as by comparing a pixel or coordinate hit with location information received at block 702.

Block 708 determines, based on the associated regions, the hierarchy of the associated regions, and the response capabilities of the associated regions, at least one region of the associated regions to target. Thus, gesture manager 210 may determine that superior region 502 should respond to the multi-input gesture received.

Block 710 targets the targeted region(s) effective to cause the application to respond to the multi-input gesture(s) through the targeted region(s). Block 710 provides, for example, a targeted region to the application after which the application responds to one multi-input gesture through the targeted region. As shown in FIG. 6 at 610, application 212 responds through superior region 502 to expand the application interface 110. This is but one example, however, as an inferior region may instead be expanded, or some other gesture may be responded to, such as to zoom into a mapping region or rotate an image, to name just a few. Further still, if more than one region is targeted, either based on one multi-input gesture or multiples, each of these regions is targeted effective to cause the application to respond to the gesture or gestures.

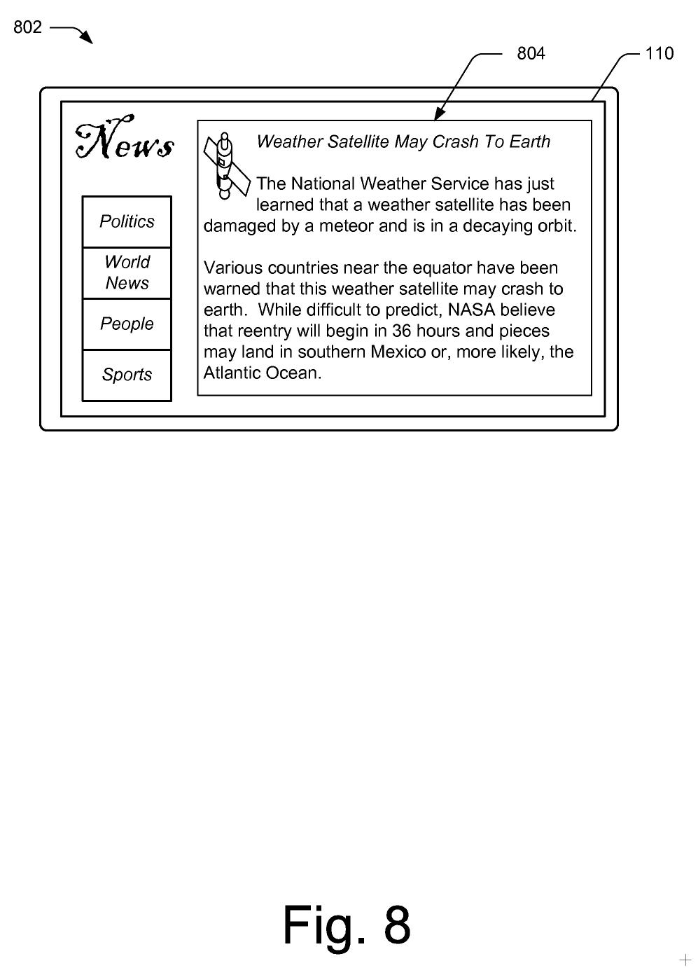

By way of further example, consider a case where gesture manager 210 targets a multi-input gesture to inferior region 506 due to inferior region 506 being capable of receiving the multi-input gesture and both initial touches landing within region 506 of FIG. 5 (not shown). In such a case, gesture manager 210 indicates to the browser type of application 212 to target the multi-input gesture to region 506. Application 212 then expands region 506 to a larger size within application interface 110 based on the initial and subsequent touches (e.g., the divergence of the initial touches). Application 212 may do so by requesting additional content from service 306 over network 106 if content cached on computing device 102 is insufficient. This is but one example, as local applications may also be used (e.g., start menus and word-processing or spreadsheet application interfaces having multiple hierarchical regions, and the like). The result of this particular example is shown in FIG. 8 at 802, application interface 110 having an expanded inferior region 804 from that of inferior region 506 of FIG. 5.

The preceding discussion describes methods relating to multi-input gestures in hierarchical regions. Aspects of these methods may be implemented in hardware (e.g., fixed logic circuitry), firmware, software, manual processing, or any combination thereof A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable memory devices, both local and/or remote to a computer processor. The methods may also be practiced in a distributed computing mode by multiple computing devices. Further, the features described herein are platform-independent and can be implemented on a variety of computing platforms having a variety of processors.

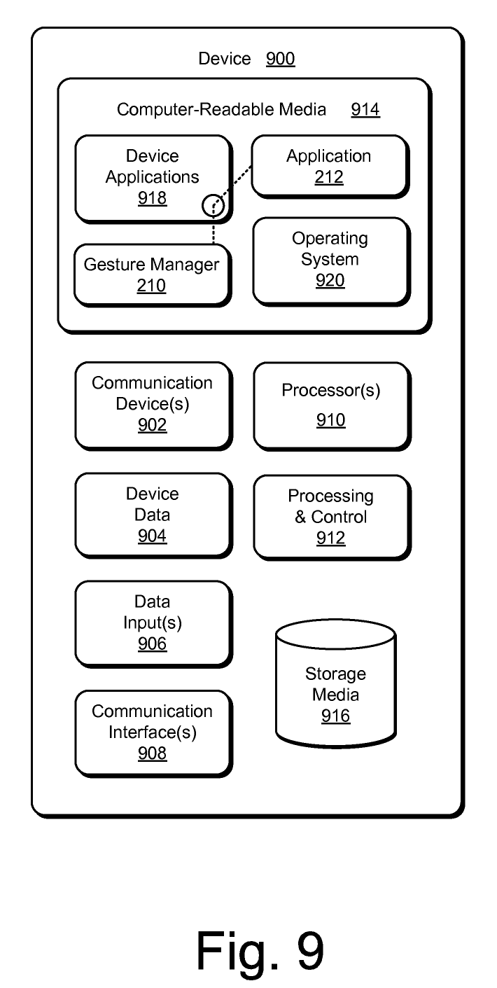

These techniques may be embodied on one or more of the entities shown in environment 100 of FIG. 1 including as detailed in FIG. 2 or 3, and/or example device 900 described below, which may be further divided, combined, and so on. Thus, environment 100 and/or device 900 illustrate some of many possible systems or apparatuses capable of employing the described techniques. The entities of environment 100 and/or device 900 generally represent software, firmware, hardware, whole devices or networks, or a combination thereof In the case of a software implementation, for instance, the entities (e.g., gesture manager 210, applications 212, and services 306) represent program code that performs specified tasks when executed on a processor (e.g., processor(s) 202 and/or 302). The program code can be stored in one or more computer-readable memory devices, such as media 204, provider media 304, or computer-readable media 914 of FIG. 9.

### Example Device

FIG. 9 illustrates various components of example device 900 that can be implemented as any type of client, server, and/or computing device as described with reference to the previous FIGS. 1-8 to implement techniques for multi-input gestures in hierarchical regions. In embodiments, device 900 can be implemented as one or a combination of a wired and/or wireless device, as a form of television client device (e.g., television set-top box, digital video recorder (DVR), etc.), consumer device, computer device, server device, portable computer device, user device, communication device, video processing and/or rendering device, appliance device, gaming device, electronic device, and/or as another type of device. Device 900 may also be associated with a user (e.g., a person) and/or an entity that operates the device such that a device describes logical devices that include users, software, firmware, and/or a combination of devices.

Device 900 includes communication devices 902 that enable wired and/or wireless communication of device data 904 (e.g., received data, data that is being received, data scheduled for broadcast, data packets of the data, etc.). The device data 904 or other device content can include configuration settings of the device, media content stored on the device, and/or information associated with a user of the device. Device 900 includes one or more data inputs 906 via which any type of data, media content, and/or inputs can be received, such as human utterances, user-selectable inputs, messages, music, television media content, recorded video content, and any other type of data received from any content and/or data source.

Device 900 also includes communication interfaces 908, which can be implemented as any one or more of a serial and/or parallel interface, a wireless interface, any type of network interface, a modem, and as any other type of communication interface. The communication interfaces 908 provide a connection and/or communication links between device 900 and a communication network by which other electronic, computing, and communication devices communicate data with device 900.

Device 900 includes one or more processors 910 (e.g., any of microprocessors, controllers, and the like), which process various computer-executable instructions to control the operation of device 900 and to enable techniques for multi-input gestures in hierarchical regions. Alternatively or in addition, device 900 can be implemented with any one or combination of hardware, firmware, or fixed logic circuitry that is implemented in connection with processing and control circuits which are generally identified at 912. Although not shown, device 900 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 900 also includes computer-readable storage media 914, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 900 can also include a mass storage media device 916.

Computer-readable storage media 914 provides data storage mechanisms to store the device data 904, as well as various device applications 918 and any other types of information and/or data related to operational aspects of device 900. For example, an operating system 920 can be maintained as a computer application with the computer-readable storage media 914 and executed on processors 910. The device applications 918 may include a device manager, such as any form of a control application, software application, signal-processing and control module, code that is native to a particular device, a hardware abstraction layer for a particular device, and so on.

The device applications 918 also include any system components, engines, or modules to implement techniques for multi-input gestures in hierarchical regions. In this example, the device applications 918 can include gesture manager 210 and applications 212.

### CONCLUSION

Although embodiments of techniques and apparatuses for multi-input gestures in hierarchical regions have been described in language specific to features and/or methods, it is to be understood that the subject of the appended claims is not necessarily limited to the specific features or methods described. Rather, the specific features and methods are disclosed as example implementations for multi-input gestures in hierarchical regions.

What is claimed is:

1. A computer-implemented method comprising:
receiving a multi-input gesture made to an application interface having a superior region and at least one inferior region, the multi-input gesture having two or more initial touches;
targeting the multi-input gesture to the superior region if:
the superior region is capable of responding to the multi-input gesture and at least one of the two or more initial touches is made to the superior region, or
the superior region is capable of responding to the multi-input gesture and the two or more initial touches are made to at least two different inferior regions.

2. A computer-implemented method as described in claim 1, further comprising targeting the multi-input gesture to the inferior region if the inferior region is capable of responding to the multi-input gesture and the two or more initial touches are made to only the inferior region.

3. A computer-implemented method as described in claim 1, further comprising targeting one of each of the two or more initial touches to one of each of two different inferior regions, respectively, if the superior region is not capable of responding to the multi-input gesture.

4. A computer-implemented method as described in claim 1, further comprising targeting the multi-input gesture to the superior region if:
the superior region is capable of responding to the multi-input gesture;
the two or more initial touches are made to the inferior region; and
the inferior region is not capable of responding to the multi-input gesture.

5. A computer-implemented method as described in claim 1, wherein the multi-input gesture is received through a touch-screen display on which the application interface is displayed.

6. A computer-implemented method as described in claim 1, wherein the superior region graphically includes the inferior region on the application interface.

7. A computer-implemented method as described in claim 1, wherein the superior region is associated with a hierarchically superior node of a markup language document on which said superior and inferior regions are associated and the inferior region is associated with an inferior node of the markup language document that is inferior to the superior node.

8. A computer-implemented method as described in claim 1, wherein the two or more initial touches of the multi-input gesture are indirect touches not contacting a screen on which the application interface is displayed.

9. A computer-implemented method as described in claim 1, wherein a first of the two or more initial touches is received to a first of the superior or the inferior region and prior to a second of the two or more initial touches, and further comprising targeting the first touch to first region prior to targeting the multi-input gesture.

10. A computer-implemented method as described in claim 9, wherein the first touch is received to the inferior region and the targeting the first touch to the first region causes the application interface to alter the inferior region in response to the first touch.

11. A computer-implemented method as described in claim 10, wherein targeting the multi-input gesture to the superior region causes the application interface to reverse the alteration to the inferior region.

12. A computer-implemented method as described in claim 1, further comprising determining that the superior region is capable of responding to the multi-input gesture prior to targeting the multi-input gesture.

13. A computer-implemented method as described in claim 12, wherein determining is responsive to receiving, from an application associated with the application interface, information indicating that the superior region is capable of responding to the multi-input gesture.

14. A computer-implemented method as described in claim 1, wherein targeting includes providing the multi-input gesture to an application associated with the application interface and indicating the superior region.

15. A computer-implemented method as described in claim 1, wherein targeting the multi-input gesture causes the application interface to pan, zoom, or rotate the superior region of the application interface.

16. A computer-implemented method comprising:
receiving information about multiple regions of an application interface, the multiple regions including at least a superior region and an inferior region, and the information indicating a size and location on the application interface, a hierarchy between the superior region and the inferior region, and a response capability to multi-input gestures;
receiving touch hits associated with two or more initial touches for one or more multi-input gestures received through the application interface, the touch hits indicating location information on the application interface where the touch hits are received;
determining, based on the touch hits and the sizes and locations of said regions, to which of said regions the two or more initial touches are associated;
determining, based on the associated regions, the hierarchy of the associated regions, and the response capabilities of the associated regions, at least one region of said associated regions to target at least one of the one or more multi-input gestures; and
targeting the at least one targeted region effective to cause the application to respond to at least one of the one or more multi-input gestures through the at least one targeted region.

17. A computer-implemented method as described in claim 16, wherein determining a region to target the one or more multi-input gestures includes targeting the superior region if the superior region is capable of responding to at least one of the one or more multi-input gestures and:
at least one of the touch hits is determined to be associated with the superior region; or
the touch hits are determined to be associated with different inferior regions.

18. A computer-implemented method as described in claim 16, wherein the one or more multi-input gestures is one multi-input gesture and the at least one targeted region is one targeted region.

19. A computer-implemented method as described in claim 16, wherein the one or more multi-input gestures include two multi-input gestures, the at least one targeted region includes two targeted regions, and targeting the at least one targeted region targets the two targeted regions effective to cause the application to respond to the two multi-input gestures through their respective two targeted regions.

20. A computer-implemented method as described in claim 16, wherein a first of the touch hits is received prior to a second of the touch hits, the first touch hit associated with a first initial touch made to a first of the superior or the inferior region and prior to a second of the two or more initial touches, and further comprising targeting the first touch hit to the first region prior to targeting the one or more multi-input gestures, the targeting the first touch hit causing the application interface to alter the first region in response to the first touch hit.
